(19) United States
(12) Patent Application Publication
(10) Pub. No.: US 2014/0123182 A1
(43) Pub. Date: May 1, 2014

(54) VIDEO CONTENT PLAYING SCHEME

(71) Applicant: KT Corporation, Seongnam-si (KR)

(72) Inventors: Kang-tae LEE, Goyang-si (KR); Yoon-su KIM, Goyang-si (KR); Jun-ryul CHOI, Seoul (KR)

(73) Assignee: KT Corporation, Seongnam-si (KR)

(21) Appl. No.: 14/069,475

(22) Filed: Nov. 1, 2013

(30) Foreign Application Priority Data
Nov. 1, 2012 (KR) 10-2012-0123112

(51) Int. Cl. H04N 21/472; H04N 21/2387; H04N 21/254

(52) U.S. Cl. CPC H04N 21/47217; H04N 21/2542; H04N 21/2387
USPC 725/37

(57) ABSTRACT

In one example embodiment, a system includes a first device configured to: play video content, display a progress bar to represent playing progress of the video content, display, on the progress bar, a first image to represent a current playing time of the video content played by the first device, and display, on the progress bar, a second image to represent a final stop time of the video content that was previously played by a second device; and a server configured to transmit, to the first device, the video content and information including the final stop time of the video content played by the second device.

### TECHNICAL FIELD

The embodiments described herein pertain generally to schemes for multiple devices to play the same video content.

### BACKGROUND

An IPTV (Internet Protocol Television) service provider provides a service that integrates the security of a telecommunication network, the content of a broadcast television network, and the ubiquity of the Internet; and further provides voice, data, and video services over one connection simultaneously. Therefore, a user cannot only make calls, access the Internet, and watch TV, but also enjoy more data, voice, and video integrated services through the IPTV service, serially or in parallel.

### SUMMARY

In one example embodiment, a system may include a first device configured to: play video content, display a progress bar to represent playing progress of the video content, display, on the progress bar, a first image to represent a current playing time of the video content played by the first device, and display, on the progress bar, a second image to represent a final stop time of the video content that was previously played by a second device; and a server configured to transmit, to the first device, the video content and information including the final stop time of the video content played by the second device.

In another example embodiment, a first device may include a data receiving unit configured to receive information including a final stop time of video content played by a second device; and a display unit configured to: play the video content, display a progress bar to represent playing progress of the video content, display, on the progress bar, a first image to represent a current playing time of the video content that is played by the first device, and display, on the progress bar, a second image to represent the final stop time of the video content that was previously played by the second device.

In yet another example embodiment, a method implemented by a first device having a user interface may include: receiving video content and information including a final stop time of the video content that was previously played by a second device; playing the video content; displaying a progress bar to represent playing progress of the video content; displaying, on the progress bar, a first image to represent a current playing time of the video content that is played by the first device; and displaying, on the progress bar, a second image to represent the final stop time of the video content that was previously played by the second device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system configuration in which one or more embodiments of a video content playing scheme may be implemented, in accordance with various embodiments described herein;

FIGS. 2A-2D show an illustrative example of a user interface and corresponding progress bar, in accordance with one or more embodiments of a video content playing scheme;

FIG. 3 shows an illustrative example of a user interface on a device by which at least portions of control of a video content playing scheme may be implemented, in accordance with various embodiments described herein;

FIG. 4 shows another illustrative example of a user interface on a device by which at least portions of control of a video content playing scheme may be implemented, in accordance with various embodiments described herein;

FIG. 5 shows an example configuration of a device by which at least portions of a video content playing scheme may be implemented, in accordance with various embodiments described herein;

FIG. 6 shows an example processing flow of operations by which at least portions of a video content playing scheme may be implemented, in accordance with various embodiments described herein;

FIG. 7 shows another example processing flow of operations by which at least portions of a video content playing scheme may be implemented, in accordance with various embodiments described herein;

FIG. 8 shows still another example processing flow of operations by which at least portions of a video content playing scheme may be implemented, in accordance with various embodiments described herein; and

FIG. 9 shows an illustrative computing embodiment, in which any of the processes and sub-processes of a video content playing scheme may be implemented as computer-readable instructions stored on a computer-readable medium, in accordance with various embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

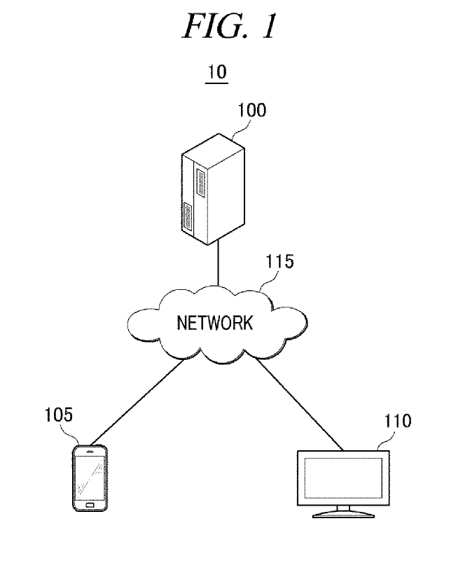

FIG. 1 shows an example system configuration in which one or more embodiments of a video content playing scheme may be implemented, in accordance with various embodiments described herein. As depicted in FIG. 1, a system configuration 10 may include, at least, a server 100, a first device 105, and a second device 110. At least two or more of server 100, first device 105, and second device 110 may be communicatively connected to each other via a network 115.

Server 100 may refer to one or more servers that are hosted on or by a service providing organization or entity that provides real-time broadcasting services, video-on-demand (VOD) services and/or user interactive services (e.g., video games) to at least first device 105 and second device 110. Server 100 may represent one or more servers or other processing apparatuses that may be configured to transmit video content to at least first device 105 and second device 110. As non-limiting examples, server 100 may be hosted on one or more of an Internet service provider (ISP); application service provider (ASP); storage service provider (SSP); and television service provider, i.e., cable TV, DSL and DBS, etc.

Further, server 100 may be configured to couple first device 105 and second device 110, communicatively. For example, but not as a limitation, server 100 may be configured to receive a first log-in identifier of first device 105 from first device 105 and to receive a second log-in identifier of second device 110 from second device 110. Further, server 100 may be configured to compare the first log-in identifier of first device 105 with the second log-in identifier of second device 110. Server 100 may communicatively couple first device 105 and second device 110, if the first log-in identifier of first device 105 is identical to the second log-in identifier of second device 110.

First device 105 and second device 110, respectively, may refer to a notebook computer; a personal computer; a smart phone; a tablet computer; a phablet device; and/or a personal communication terminal, such as PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminals.

In accordance with some example embodiments, second device 110 may be configured to transmit a request for video content to server 100 and server 100 may be configured to transmit the requested video content to second device 110 in response to the request. Second device 110 may be configured to then receive the video content, and to play the received video content. When second device 110 stops playing the received video content, second device 110 may be configured to transmit, to server 100, information regarding a final stop time of the video content. The final stop time may refer to a point in time, relative to the total playing time of the received video content, at which the playing of the video content was stopped.

Further to the example embodiments, first device 105 may be configured to transmit, to server 100, a request for the video content that was previously played by second device 110 and server 100 may be configured to transmit the requested video content to first device 105 in response to the request. Further, server 100 may be configured to transmit, to first device 105, the information regarding the final stop time of the video content that was previously played by second device 110. First device 105 may be configured to then receive the video content and the information regarding the final stop time, and to play the received video content.

Further, first device 105 may be configured to display a progress bar that represents playing progress of the video content on a display that is communicatively coupled to first device 105. For example, but not as a limitation, the display on which first device 105 displays the progress bar may include a touch screen that has a touch-sensitive surface coupled to first device 105. The touch screen may be implemented by using liquid crystal display (LCD) technology, light emitting diode (LED) technology, or light emitting polymer display (LPD) technology.

First device 105 may be further configured to display a first image, on the displayed progress bar, to represent a current playing time of the video content that is currently played by first device 105. Further, first device 105 may be configured to display, on the displayed progress bar, a second image to represent the final stop time of the video content that was previously played by second device 110, based at least in part on the received information regarding the final stop time of the video content of second device 110.

First device 105 may be further configured to display, on the display, a first device icon that represents first device 105 in association with the first image, which represents the current playing time of the video content played by first device 105, relative to the total playing time of the video content. First device 105 may be further configured to display, also on the display, a second device icon that represents second device 110 in association with the second image, which represents the final stop time of the video content that was previously played by second device 110.

For example, but not as a limitation, first device 105 may be configured to display the first device icon below the displayed first image on the display, and to display the second device icon below the displayed second image on the display. By way of another example, first device 105 may be configured to display the first device icon to be overlaid with the displayed first image on the display, and to display the second device icon to be overlaid with the displayed second image on the display.

In some embodiments, first device 105 may be configured to receive an input to select the second device icon. First device 105 may be configured to then play the video content starting from a point in time, relative to the total playing time of the video content, corresponding to the final stop time of the video content that was previously played by second device 110. That is, the video content may be played, on first device 105, starting from a frame corresponding to the final stop time from among total frames of the video content.

In some embodiments, first device 105 may be configured to display a user interface that may be configured to include a content sharing icon and a play icon on the display. The content sharing icon may be configured to receive user input instructions to authorize second device 110 to play the video content. For example, first device 105 may be configured to transmit, to server 100, a signal to request server 100 to authorize second device 110 to play the video content, if first device 105 receives a user input to the content sharing icon. Further, server 100 may be configured to then authorize second device 110 to play the video content.

In some embodiments, first device 105 may be configured to deactivate the content sharing icon, if second device 110 is unable to share the video content or if there is no need to share the video content with second device 110. For example, but not as a limitation, if the video content is rated to be appropriate for viewers over 17 years of age but a user of second device 110 is less than 17 years of age, second device 110 may be unable to share the video content. Server 100 may be configured to then transmit, to first device 105, information indicating that the user of second device 110 is a minor, so second device 110 is unable to play the video content. Upon receiving the information from server 100, first device 105 may be configured to then deactivate the content sharing icon. By way of another example, first device 105 may be configured to receive, from server 100, purchase information to indicate whether the video content has been purchased or rented for playing on second device 110 or if the video content has been shared with second device 110. First device 105 may be configured to deactivate the content sharing icon based at least in part on the received purchase information. If the video content has been purchased or rented for playing on second device 110 or if the video content has been already shared with second device 110, the sharing of the video content is not necessary to second device 110. Then, first device 105 may be configured to deactivate the content sharing icon.

The play icon may be configured to receive user input instructions for second device 110 to play the video content starting from the current playing time of the video content that is currently played by first device 105. If first device 105 receives a user input to the play icon, first device 105 may be configured to transmit, to server 100, a signal indicative of the received input instructions for second device 110 to play the video content starting from the current playing time as well as information including the current playing time.

Server 100 may be configured to determine whether second device 110 is currently capable of playing the video content, when server 100 receives the signal indicative of the received input to the play icon from first device 105. Server 100 may be configured to transmit a message that indicates that second device 110 is unable to play the video content to first device 105, if second device 110 is determined to be currently unable to play the video content (e.g., second device 110 is currently turned off).

Further, if second device 110 is determined to be currently capable of playing the video content, server 100 may be configured to transmit, to second device 110, a control signal to instruct second device 110 to play the video content starting from the current playing time on first device 105. Further, server 100 may be configured to transmit the video content and the information including the current playing time of the video content played by first device 105 to second device 110. Second device 110 may be configured to then play the video content starting from a time point corresponding to the current playing time of the video content that is played by first device 105. That is, the video content may be played starting from a frame corresponding to the current playing time from among total frames of the video content by second device 110.

In some embodiments, first device 105 may be configured to deactivate the play icon, if second device 110 is currently unable to play the video content. For example, but not as a limitation, if the video content is rated to be appropriate for viewers over 17 years of age but a user of second device 110 is less than 17 years of age, or if second device 110 is currently turned off, second device 110 may be currently unable to play the video content. Server 100 may be configured to then transmit, to first device 105, information indicating that the user of second device 110 is a minor or second device 110 is currently turned off, so second device 110 is currently unable to play the video content. Upon receiving the information from server 100, first device 105 may be configured to deactivate the play icon.

In some embodiments, first device 105 may be configured to receive a touch input that drags the touch input from a first predetermined area to a second predetermined area on the touch screen. Such a touch input may be characterized or otherwise referred to as a “sweeping input.”. For example, but not as a limitation, a user of first device 105 may activate a touch input to the touch screen using any suitable object or appendage, such as a stylus, finger, and so forth. First device 105 may be configured to recognize the touch input by using one or more multiple touch sensitivity technologies, including but not limited to capacitive, resistive, infrared, and surface acoustic wave technologies, as well as other proximity sensor arrays or other elements for determining one or more points of contact with the touch screen.

Further, first device 105 may be configured to generate a signal to request second device 110 to play the video content, in response to the sweeping input. For example, first device 105 may be configured to generate a signal to request server 100 to instruct second device 110 to play the video content starting from the current playing time on first device 105, in response to the sweeping input on first device 105. Further, first device 105 may be configured to transmit the generated signal and information, including the current playing time of first device 105 to server 100. Server 100 may be configured to then transmit, to second device 110, a control signal to instruct second device 110 to play the video content starting from the current playing time. Further, server 100 may be configured to transmit the video content and the information including the current playing time of the video content played by first device 105 to second device 110. Then, second device 110 may be configured to play the video content starting from a point in time, relative to the total playing time of the video content, corresponding to the current playing time on first device 105.

In some embodiments, first device 105 may be configured to display a thumbnail image that corresponds to the final stop time of the video content that was previously displayed by second device 110 on the display. By way of example, first device 105 may be configured to then play the video content starting from the final stop time, when first device 105 receives an input to select the thumbnail image. That is, the video content may be played starting from a frame corresponding to the thumbnail image from among total frames of the video content by first device 105.

Network 115 may be configured to communicatively couple two or more of server 100, first device 105, and second device 110. Network 115 may be implemented in accordance with any wired network protocol, such as LAN (Local Area Network), WAN (Wide Area Network), VAN (Value Added Network) or the like, or any wireless network protocol, such as a mobile radio communication network including at least one of a 3rd generation (3G) mobile telecommunications network, a 4th generation (4G) mobile telecommunications network, any other mobile telecommunications networks, a satellite network, WiBro (Wireless Broadband Internet), Mobile WiMAX, HSDPA (High Speed Downlink Packet Access) or the like. Alternatively, network 115 may include at least one of a near field communication (NFC), Bluetooth, or peer to peer (P2P) communication protocol.

Thus, FIG. 1 shows example system configuration 10 in which one or more embodiments of a video content playing scheme may be implemented, in accordance with various embodiments described herein.

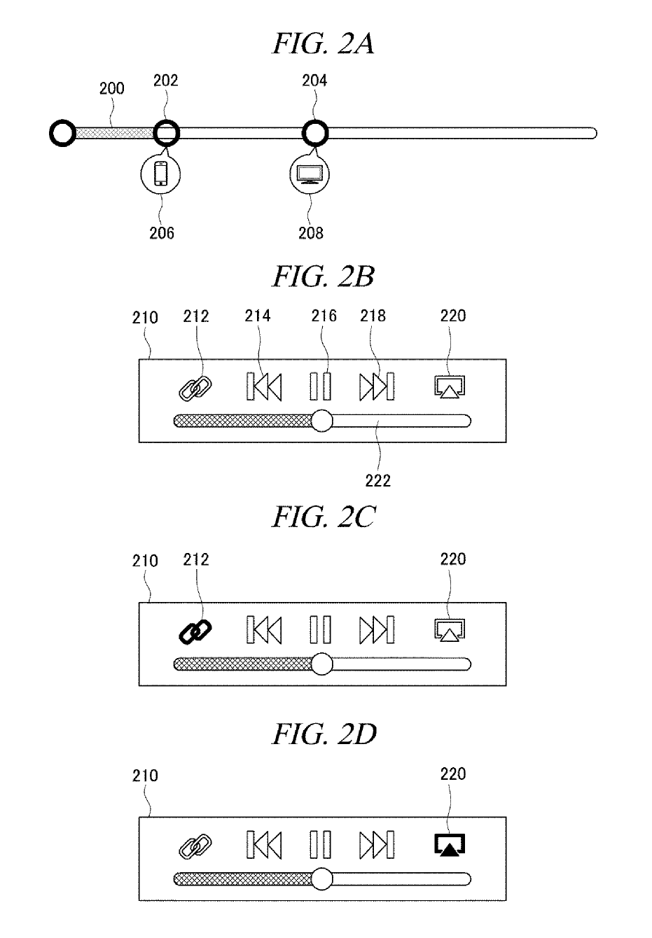

FIGS. 2A-2D show an illustrative example of a user interface and corresponding progress bar, in accordance with one or more embodiments of a video content playing scheme. FIG. 2A shows an illustrative example of a progress bar 200 in accordance with one or more embodiments of a video content playing scheme. As depicted in FIG. 2A, a progress bar 200 may be configured to represent playing progress of video content on first device 105. Further, a first image 202 that may be configured to represent a current playing time of the video content on first device 105 may be displayed on progress bar 200. Further, a second image 204 that may be configured to represent a final stop time of the video content that was previously played on second device 110 may be displayed on progress bar 200. Further, a first device icon 206 that may be configured to represent first device 105 may be displayed below first image 202, and a second device icon 208 that may be configured to represent second device 110 may be displayed below second image 204.

FIG. 2B shows an illustrative example of a user interface 210 that may include a content sharing icon 212, a rewind icon 214, a pause icon 216, a fast forward icon 218, a play icon 220 and a volume control bar 222. Content sharing icon 212 may be configured to receive input instructions to authorize second device 110 to play the video content. Rewind icon 214 may be configured to receive input instructions to rewind the video content. Pause icon 216 may be configured to receive input instructions to pause the video content. Fast forward icon 218 may be configured to receive input instructions to fast forward the video content. Play icon 220 may be configured to receive input instructions for second device 110 to play the video content starting from the current playing time of the video content that is currently played on first device 105. Volume control bar 222 may be configured to receive input instructions to turn a volume of the video content up or down.

FIG. 2C shows another illustrative example of user interface 210 including a deactivated content sharing icon 212 in accordance with one or more embodiments of a video content playing scheme. As depicted in FIG. 2C, first device 105 may be configured to deactivate content sharing icon 212, if sharing of the video content with second device 110 is not necessary. For example, if the video content has been purchased or rented for playing on second device 110 or if the video content has been already shared with second device 110, first device 105 may be configured to deactivate content sharing icon 212.

FIG. 2D shows still another illustrative example of user interface 210 including a deactivated play icon 220 in accordance with one or more embodiments of a video content playing scheme. As depicted in FIG. 2D, first device 105 may be configured to deactivate play icon 220, if second device 110 is not currently capable of playing the video content. By way of example, if second device 110 is currently turned off, first device 105 may be configured to deactivate play icon 220.

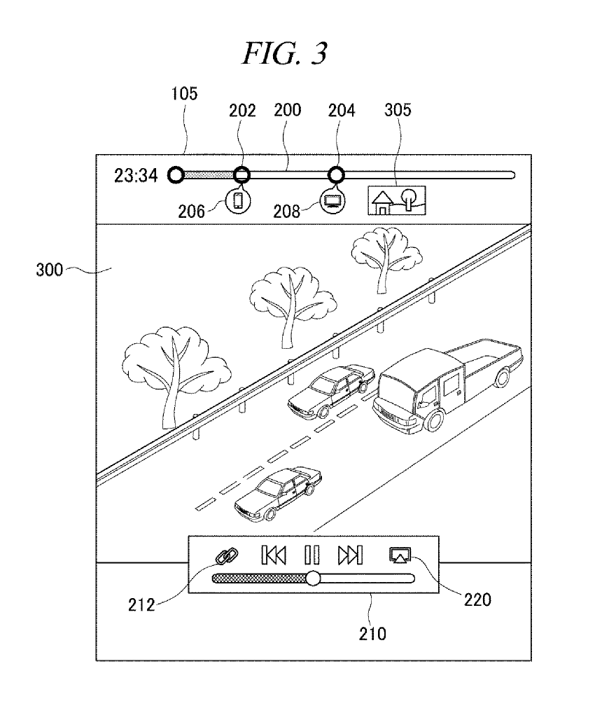

FIG. 3 shows an illustrative example of a user interface on a device by which at least portions of control of a video content playing scheme may be implemented, in accordance with various embodiments described herein.

As depicted in FIG. 3, first device 105 may be configured to play video content. By way of example, but not limitation, first device 105 may be configured to display a frame image 300 that shows a frame or scene from the video content at the current playing time of first device 105, from among total frames included in the video content. Further, first device 105 may be configured to further display progress bar 200 to represent playing progress of the video content at any point on the same display as displayed frame image 300. Further, first device 105 may be configured to display first image 202 and second image 204 on progress bar 200. Further, first device 105 may be configured to display first device icon 206 in accordance with first image 202 and to display second device icon 208 in accordance with second image 204. Further, first device 105 may be configured to display a thumbnail image 305 that represents a frame image corresponding to a final stop time of the video content that was previously played by second device 110. Further, first device 105 may be configured to display user interface 210 including content sharing icon 212 and play icon 220 below, or otherwise near displayed frame image 300.

Thus, FIG. 3 shows an illustrative example of a user interface on a device by which at least portions of control of a video content playing scheme may be implemented, in accordance with various embodiments described herein.

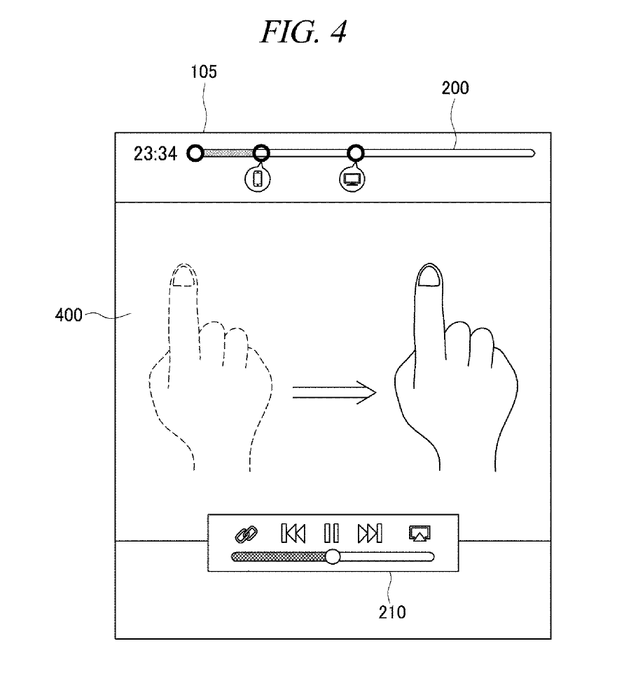

FIG. 4 shows another illustrative example of a user interface on a device by which at least portions of control of a video content playing scheme may be implemented, in accordance with various embodiments described herein. As depicted in FIG. 4, first device 105 may be configured to receive a touch, e.g., sweeping, input that moves from a first predetermined area to a second predetermined area on a display 400.

In some embodiments, when first device 105 receives the sweeping input, first device 105 may be configured to generate a signal to request second device 110 to play the video content starting from the current playing time. Further, first device 105 may be configured to transmit the generated signal and information including the current playing time on first device 105 to server 100. Server 100 may be configured to then transmit, to second device 110, a control signal to instruct second device 110 to play the video content starting from the current playing time on first device 105. Further, server 100 may be configured to transmit the video content and the information including the current playing time of the video content played on first device 105 to second device 110. Then, the video content may be played starting from a time point corresponding to the current playing time of first device 105 by second device 110.

Thus, FIG. 4 shows another illustrative example of a user interface on a device by which at least portions of control of a video content playing scheme may be implemented, in accordance with various embodiments described herein.

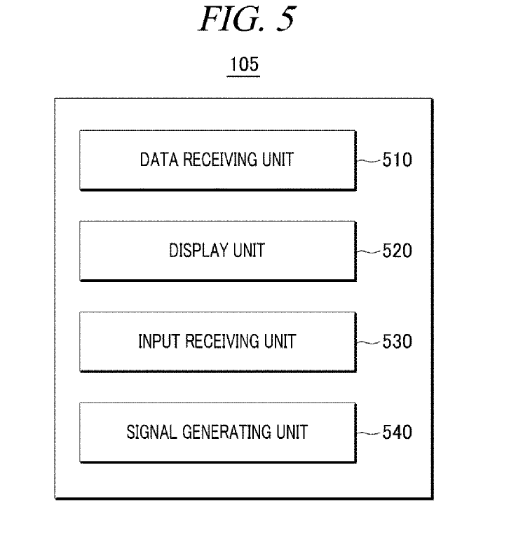

FIG. 5 shows an example configuration of a device by which at least portions of a video content playing scheme may be implemented, in accordance with various embodiments described herein. As depicted in FIG. 5, for example, first device 105 may include a data receiving unit 510, a display unit 520, an input receiving unit 530 and a signal generating unit 540. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or any combination thereof. In that regard, one or more of data receiving unit 510, display unit 520, input receiving unit 530 and signal generating unit 540 may be included in an instance of an application hosted on first device 105 or second device 110.

Data receiving unit 510 may be configured to transmit a request for video content to server 100 and to receive the requested video content from server 100. Further, data receiving unit 510 may be configured to receive, from server 100, information including a final stop time of the video content that was previously displayed by second device 110. Further, data receiving unit 510 may be configured to receive, from server 100, purchase information to indicate whether second device 110 has purchased the video content or whether the video content has been provided to second device 110.

Display unit 520 may be configured to play the video content received by data receiving unit 510. Further, display unit 520 may be configured to display progress bar 200 that represents playing progress of the video content. For example, but not as a limitation, display unit 520 may include a touch screen that has a touch-sensitive surface coupled to first device 105. The touch screen may be implemented by using liquid crystal display (LCD) technology, light emitting diode (LED) technology, or light emitting polymer display (LPD) technology.

Display unit 520 may be further configured to display first image 202 to represent a current playing time of the video content that is currently played by first device 105 on displayed progress bar 200. Further, display unit 520 may be configured to display second image 204 to represent the final stop time of the video content that was previously played by second device 110 on displayed progress bar 200, based at least in part on the information including the final stop time of the video content of second device 110, which is received by data receiving unit 510.

Further, display unit 520 may be configured to display first device icon 206 that represents first device 105 in association with first image 202. Display unit 520 may be further configured to display second device icon 208 that represents second device 110 in association with the second image 204. For example, but not as a limitation, display unit 520 may be configured to display first device icon 206 to be overlaid with first image 202 and to display second device icon 208 to be overlaid with second image 204.

Further, display unit 520 may be configured to display content sharing icon 212 to receive input instructions to authorize second device 110 to play the video content. Further, display unit 520 may be configured to deactivate content sharing icon 212, based at least in part on the purchase information received by data receiving unit 510. For example, if second device 110 has already purchased or rented the video content or if the video content has been already shared with second device 110, display unit 520 may be configured to deactivate content sharing icon 212.

Further, display unit 520 may be configured to display play icon 220 to receive input instructions for second device 110 to play the video content starting from the current playing time of the video content that is currently played by first device 105. Further, display unit 520 may be configured to deactivate play icon 220, if second device 110 is currently unable to play the video content. For example, but not as a limitation, if second device 110 is currently turned off, second device 110 may be currently unable to play the video content, so display unit 520 may be configured to deactivate play icon 220.

In some embodiments, display unit 520 may be configured to display a thumbnail image that corresponds to the final stop time of the video content that was previously displayed by second device 110.

Input receiving unit 530 may be configured to receive an input to select second device icon 208. Then, display unit 520 may be configured to play the video content starting from the final stop time of the video content that was previously played by second device 110.

Further, input receiving unit 530 may be configured to receive an input to at least one of content sharing icon 212 or play icon 220.

Further, input receiving unit 530 may be configured to receive an input to the thumbnail image that represents a frame or a scene corresponding to the final stop time. Then, display unit 520 may be configured to play the video content starting from the final stop time of the video content that was previously played by second device 110.

In some embodiments, input receiving unit 530 may be configured to receive a sweeping input that moves from a first predetermined area to a second predetermined area on display unit 520.

Signal generating unit 540 may be configured to generate a signal to request server 100 to allow second device 110 to have an authority capable of playing the video content, when input receiving unit 530 receives an input to the content sharing icon. Further, signal generating unit 540 may be configured to transmit the generated signal to server 200. Server 100 may be configured to then authorize second device 110 to play the video content.

Further, signal generating unit 540 may be configured to generate a signal indicative of instructions for second device 110 to play the video content starting from the current playing time of first device 105, when input receiving unit 530 receives an input to play icon 220. Further, signal generating unit 540 may be configured to transmit the generated signal and information including the current playing time to server 100.

Further, signal generating unit 540 may be configured to generate a signal to request second device 110 to play the video content, when input receiving unit 530 receives the sweeping input. For example, signal generating unit 540 may be configured to generate a signal to request server 100 to instruct second device 110 to play the video content starting from the current playing time, when input receiving unit 530 receives the sweeping input. Further signal generating unit 540 may be configured to transmit the generated signal and information including the current playing time of first device 105 to server 100.

Thus, FIG. 5 shows an example configuration of a device by which at least portions of a video content playing scheme may be implemented, in accordance with various embodiments described herein.

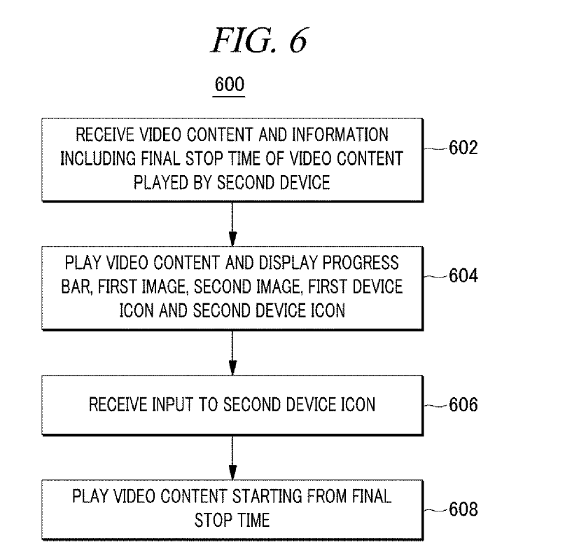

FIG. 6 shows an example processing flow 600 of operations by which at least portions of a video content playing scheme may be implemented, in accordance with various embodiments described herein. The operations of processing flow 600 may be implemented in server 100 including data receiving unit 510, display unit 520, input receiving unit 530 and signal generating unit 540, as illustrated in FIG. 5. Processing flow 600 may include one or more operations, actions, or functions as illustrated by one or more blocks 602, 604, 606 and/or 608. Although illustrated as discrete blocks, various blocks may be divided into additional blocks, combined into fewer blocks, or eliminated, depending on the desired implementation. Processing may begin at block 602.

Block 602 (Receive Video Content and Information Including Final Stop Time of Video Content Played by Second Device) may refer to data receiving unit 510 receiving, from server 100, video content and information including a final stop time of the video content that was previously played by second device 110. Processing may proceed from block 602 to block 604.

Block 604 (Play Video Content and Display Progress Bar, First Image, Second Image, First Device Icon and Second Device Icon) may refer to displaying unit 520 playing the video content and displaying a progress bar to represent playing progress of the video content, a first image to represent a current playing time of the video content that is currently played by first device 105, a second image to represent the final stop time of the video content that was previously played by second device 110, a first device icon to represent first device 105 and a second device icon to represent second device 110. Processing may proceed from block 604 to block 606.

Block 606 (Receive Input to Second Device Icon) may refer to input receiving unit 530 receiving an input to select the second device icon displayed at block 604. Processing may proceed from block 606 to block 608.

Block 608 (Play Video Content Starting from Final Stop Time) may refer to display unit 520 playing the video content starting from the final stop time of the video content that was previously played by second device 110. For example, at block 608, the video content may be played starting from a frame corresponding to the final stop time from among total frames of the video content by first device 105.

Thus, FIG. 6 shows an example processing flow of operations by which at least portions of a video content playing scheme may be implemented, in accordance with various embodiments described herein.

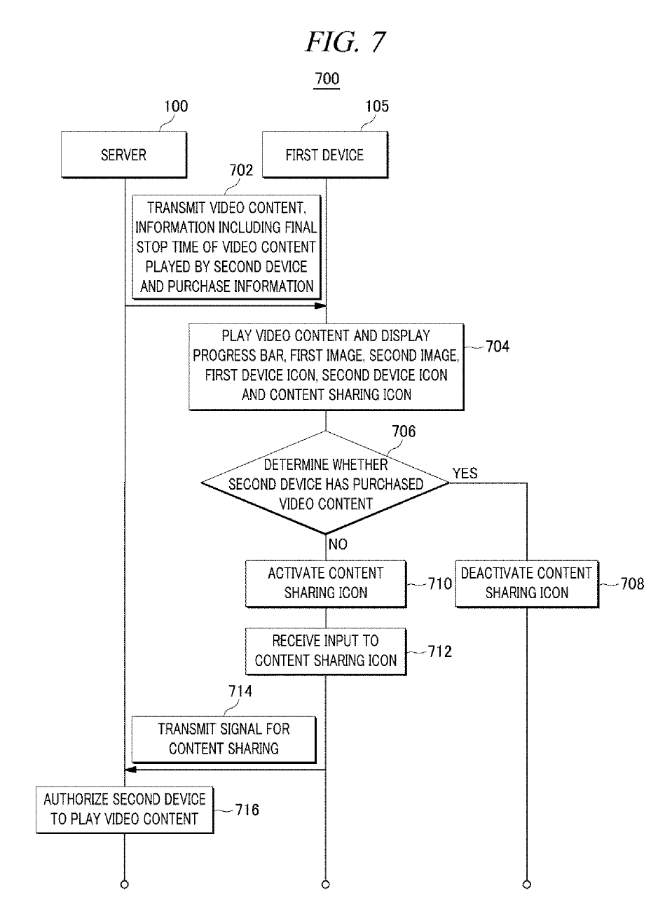

FIG. 7 shows another example processing flow of operations by which at least portions of a video content playing scheme may be implemented, in accordance with various embodiments described herein. The operations in FIG. 7 may be implemented in system configuration 10 including server 100, first device 105 and second device 110, as illustrated in FIG. 1. An example process may include one or more operations, actions, or functions as illustrated by one or more blocks 702, 704, 706, 708, 710, 712, 714 and/or 716. Although illustrated as discrete blocks, various blocks may be divided into additional blocks, combined into fewer blocks, or eliminated, depending on the desired implementation. Processing may begin at block 702.

Block 702 (Transmit Video Content, Information Including Final Stop Time of Video Content Played by Second Device and Purchase Information) may refer to server 100 transmitting, to first device 105, video content, information including a final stop time of the video content that was previously played by second device 110 and purchase information to indicate whether second device 110 has purchased or rented the video content. In some embodiments, before first device 105 plays the video content, second device 110 may play the video content. After a while, when second device 110 stops to play the video content, second device 110 may be configured to transmit the information regarding the final stop time to server 100. Further, if second device 110 purchases the video content, server 100 may store the purchase information regarding purchasing log of second device 100. Then, server 100 may provide the video content, the information regarding the final stop time and the purchase information to first device 105, when server 100 receives a request for the video content from first device 105. Processing may proceed from block 702 to block 704.

Block 704 (Play Video Content and Display Progress Bar, First Image, Second Image, First Device Icon, Second Device Icon and Content Sharing Icon) may refer to first device 105 playing the video content and displaying a progress bar to represent playing progress of the video content, a first image to represent a current playing time of the video content that is currently played by first device 105, a second image to represent the final stop time of the video content that was previously played by second device 110, a first device icon to represent first device 105, a second device icon to represent second device 110 and a content sharing icon to receive input instructions to authorize second device 110 to play the video content. Processing may proceed from block 704 to block 706.

Block 706 (Determine Whether Second Device Has Purchased Video Content) may refer to first device 105 determining whether second device 110 has already purchased the video content based on the purchase information received at block 702. For example, if second device 110 has purchased the video content, the purchase information may include at least some of an identifier of the video content, a date when second device 110 purchased the video content, or a price of the video content. Otherwise, if second device 110 did not purchase the video content, the purchase information may not include a purchasing log. If first device 105 determines that second device 110 has purchased the video content, processing may proceed from block 706 to block 708, while otherwise, processing may proceed from block 706 to block 710.

Block 708 (Deactivate Content Sharing Icon) may refer to first device 105 deactivating the content sharing icon.

Block 710 (Activate Content Sharing Icon) may refer to first device 105 activating the content sharing icon. Processing may proceed from block 710 to block 712.

Block 712 (Receive Input to Content Sharing Icon) may refer to first device 105 receiving an input to the content sharing icon activated at block 710. Processing may proceed from block 712 to block 714.

Block 714 (Transmit Signal for Content Sharing) may refer to first device 105 transmitting a signal for content sharing of the video content to server 100. At block 714, first device 105 may transmit, to server 100, a signal to request server 100 to authorize second device 110 to play the video content. Processing may proceed from block 714 to block 716.

Block 716 (Authorize Second Device to Play Video Content) may refer to server 100 authorizing second device 110 to play the video content. Then, second device 110 may be in a state having an authority capable of playing the video content.

Thus, FIG. 7 shows another example processing flow of operations by which at least portions of a video content playing scheme may be implemented, in accordance with various embodiments described herein.

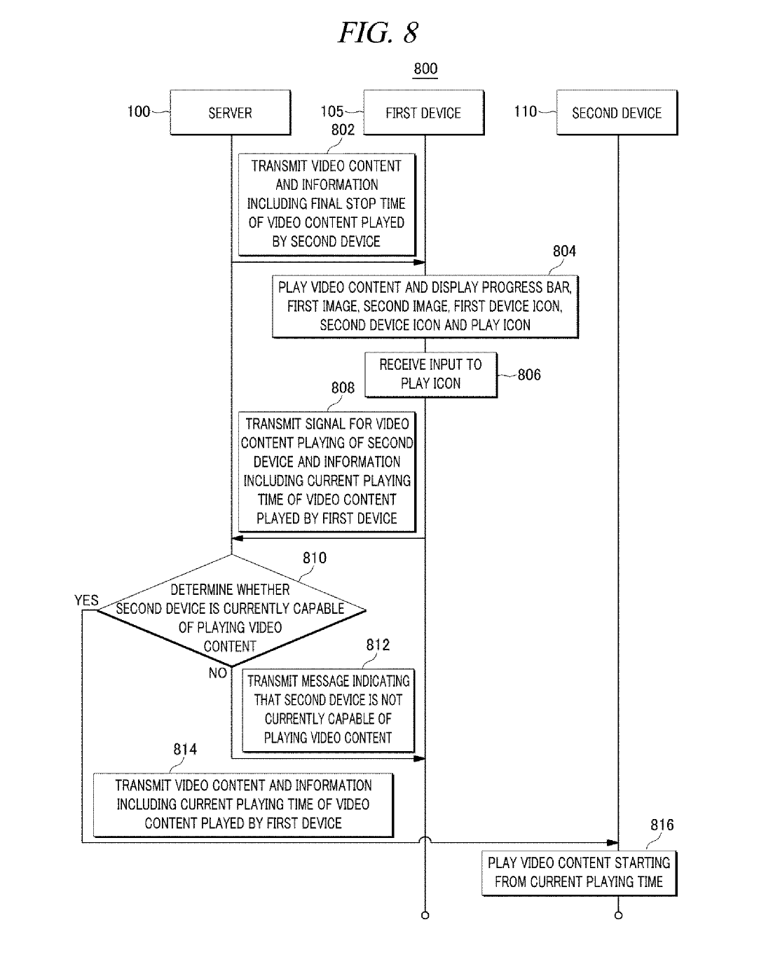

FIG. 8 shows still another example processing flow of operations by which at least portions of a video content playing scheme may be implemented, in accordance with various embodiments described herein. The operations in FIG. 8 may be implemented in system configuration 10 including server 100, first device 105 and second device 110, as illustrated in FIG. 1. An example process may include one or more operations, actions, or functions as illustrated by one or more blocks 802, 804, 806, 808, 810, 812, 814 and/or 816. Although illustrated as discrete blocks, various blocks may be divided into additional blocks, combined into fewer blocks, or eliminated, depending on the desired implementation. Processing may begin at block 802.

Block 802 (Transmit Video Content and Information Including Final Stop Time of Video Content Played by Second Device) may refer to server 100 transmitting, to first device 105, video content and information including a final stop time of the video content that was previously played by second device 110. In some embodiments, before first device 105 plays the video content, second device 110 may play the video content. After a while, if second device 110 stops to play the video content, second device 110 may be configured to transmit the information regarding the final stop time to server 100. Then, server 100 may provide the video content and the information regarding the final stop time to first device 105, when server 100 receives a request for the video content from first device 105. Processing may proceed from block 802 to block 804.

Block 804 (Play Video Content and Display Progress Bar, First Image, Second Image, First Device Icon, Second Device Icon and Play Icon) may refer to first device 105 playing the video content and displaying a progress bar to represent playing progress of the video content, a first image to represent a current playing time of the video content that is currently played by first device 105, a second image to represent the final stop time of the video content that was previously played by second device 110, a first device icon to represent first device 105, a second device icon to represent second device 110 and a play icon to receive input instructions for second device 110 to play the video content starting from the current playing time of first device 105. Processing may proceed from block 804 to block 806.

Block 806 (Receive Input to Play Icon) may refer to first device 105 receiving an input to the play icon displayed at block 804. Processing may proceed from block 806 to block 808.

Block 808 (Transmit Signal for Video Content Playing of Second Device and Information Including Current Playing Time of Video Content Played by First Device) may refer to first device 105 transmitting, to server 100, a signal for video content playing of second device 110 and information including the current playing time of the video content that is currently played by first device 105. At block 808, first device 105 may transmit a signal indicative of instructions for second device 110 to play the video content starting from the current playing time of first device 105 to server 100. Processing may proceed from block 808 to block 810.

Block 810 (Determine Whether Second Device is Currently Capable of Playing Video Content) may refer to server 100 determining whether second device 110 is currently capable of playing the video content. For example, server 100 may determine whether second device 110 is turned off. If server 100 determines that second device 110 is not currently capable of playing the video content, processing may proceed from block 810 to block 812, while otherwise, processing may proceed from block 810 to block 814.

Block 812 (Transmit Message Indicating that Second Device is Not Currently Capable of Playing Video Content) may refer to server 100 transmit a message that indicates that second device 110 is not currently capable of playing the video content to first device 105.

Block 814 (Transmit Video Content and Information Including Current Playing Time of Video Content Played by First Device) may refer to server 100 transmitting, to second device 110, the video content and the information including the current playing time of the video content played by first device 105. Processing may proceed from block 814 to block 816.

Block 816 (Play Video Content Starting from Current Playing Time) may refer to second device 110 playing the video content starting from the current playing time of the video content that is played by first device 105. For example, at block 816, the video content may be played starting from a frame corresponding to the current playing time from among total frames of the video content by second device 110.

Thus, FIG. 8 shows still another example processing flow of operations by which at least portions of a video content playing scheme may be implemented, in accordance with various embodiments described herein.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

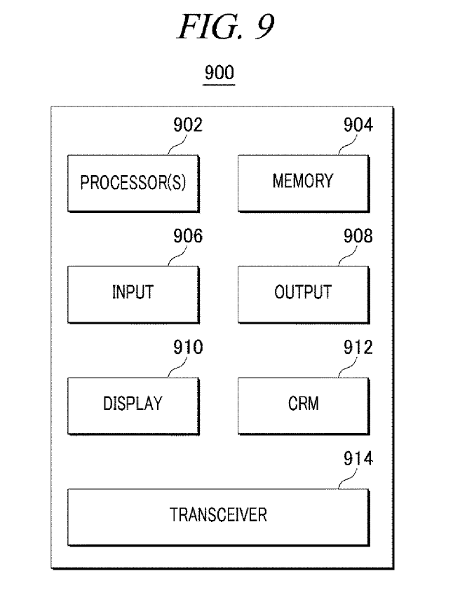

FIG. 9 shows an illustrative computing embodiment, in which any of the processes and sub-processes of a video content playing scheme may be implemented as computer-readable instructions stored on a computer-readable medium, in accordance with various embodiments described herein. The computer-readable instructions may, for example, be executed by a processor of a device, as referenced herein, having a network element and/or any other device corresponding thereto, particularly as applicable to the applications and/or programs described above corresponding to the configuration 10 for transactional permissions.

In a very basic configuration, a computing device 900 may typically include, at least, one or more processors 902, a system memory 904, one or more input components 906, one or more output components 908, a display component 910, a computer-readable medium 912, and a transceiver 914.

Processor 902 may refer to, e.g., a microprocessor, a microcontroller, a digital signal processor, or any combination thereof.

Memory 904 may refer to, e.g., a volatile memory, non-volatile memory, or any combination thereof. Memory 904 may store, therein, an operating system, an application, and/or program data. That is, memory 904 may store executable instructions to implement any of the functions or operations described above and, therefore, memory 904 may be regarded as a computer-readable medium.

Input component 906 may refer to a built-in or communicatively coupled keyboard, touch screen, or telecommunication device. Alternatively, input component 906 may include a microphone that is configured, in cooperation with a voice-recognition program that may be stored in memory 904, to receive voice commands from a user of computing device 900. Further, input component 906, if not built-in to computing device 900, may be communicatively coupled thereto via short-range communication protocols including, but not limitation, radio frequency or Bluetooth.

Output component 908 may refer to a component or module, built-in or removable from computing device 900, that is configured to output commands and data to an external device.

Display component 910 may refer to, e.g., a solid state display that may have touch input capabilities. That is, display component 910 may include capabilities that may be shared with or replace those of input component 906.

Computer-readable medium 912 may refer to a separable machine readable medium that is configured to store one or more programs that embody any of the functions or operations described above. That is, computer-readable medium 912, which may be received into or otherwise connected to a drive component of computing device 900, may store executable instructions to implement any of the functions or operations described above. These instructions may be complimentary or otherwise independent of those stored by memory 904.

Transceiver 914 may refer to a network communication link for computing device 900, configured as a wired network or direct-wired connection. Alternatively, transceiver 914 may be configured as a wireless connection, e.g., radio frequency (RF), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A system, comprising:
a first device configured to:
play video content,
display a progress bar to represent playing progress of the video content,
display, on the progress bar, a first image to represent a current playing time of the video content played by the first device, and
display, on the progress bar, a second image to represent a final stop time of the video content that was previously played by a second device; and
a server configured to transmit, to the first device, the video content and information including the final stop time of the video content played by the second device.

2. The system of claim 1, wherein the server is further configured to:
compare a first log-in identifier of the first device with a second log-in identifier of the second device, and
communicatively couple the first device to the second device, if the first log-in identifier is identical to the second log-in identifier.

3. The system of claim 1, wherein the first device is further configured to:
display a first device icon to represent the first device in association with the first image, and
display a second device icon to represent the second device in association with the second image.

4. The system of claim 3, wherein the first device is further configured to:
receive an input to select the second device icon; and
play the video content starting from the final stop time.

5. The system of claim 1, wherein the first device is further configured to:
display a play icon that is configured to receive input instructions for the second device to play the video content starting from the current playing time; and
transmit, to the server, a signal indicative of the received input instructions for the second device to play the video content starting from the current playing time and information including the current playing time, and
wherein the server is further configured to:
transmit, to the second device, the video content and the information including the current playing time of the video content played by the first device.

6. The system of claim 5, wherein the server is further configured to determine whether the second device is currently capable of playing the video content.

7. The system of claim 1, wherein the first device is further configured to:
display a content sharing icon that is configured to receive input instructions to authorize the second device to play the video content.

8. The system of claim 7, wherein the first device is further configured to:
receive purchase information to indicate whether the second device has purchased the video content from the server, and
deactivate or activate the content sharing icon based at least in part on the purchase information.

9. A first device, comprising:
a data receiving unit configured to receive information including a final stop time of video content played by a second device; and
a display unit configured to:
play the video content,
display a progress bar to represent playing progress of the video content,
display, on the progress bar, a first image to represent a current playing time of the video content that is played by the first device, and
display, on the progress bar, a second image to represent the final stop time of the video content that was previously played by the second device.

10. The first device of claim 9, wherein the display unit is further configured to:
display a first device icon to represent the first device in association with the first image, and
display a second device icon to represent the second device in association with the second image.

11. The first device of claim 10, wherein the display unit is further configured to display a content sharing icon that is configured to receive input instructions to authorize the second device to play the video content.

12. The first device of claim 11, wherein the display unit is further configured to deactivate the content sharing icon if the second device has already purchased the video content or if the video content has been already shared with the second device.

13. The first device of claim 9, wherein the display unit is further configured to display a play icon that is configured to receive input instructions for the second device to play the video content starting from the current playing time.

14. The first device of claim 9, further comprising:
an input receiving unit configured to receive a sweeping input that moves on the display unit from a first predetermined area of the display unit to a second predetermined area of the display unit; and
a signal generating unit configured to:
generate a signal to request the second device to play the video content starting from the current playing time, when the input receiving unit receives the sweeping input, and
transmit the generated signal.

15. The first device of claim 9, wherein the display unit is further configured to display a thumbnail image corresponding to the final stop time.

16. A method implemented by a first device having a user interface, comprising:
receiving video content and information including a final stop time of the video content that was previously played by a second device;
playing the video content;
displaying a progress bar to represent playing progress of the video content;
displaying, on the progress bar, a first image to represent a current playing time of the video content that is played by the first device; and
displaying, on the progress bar, a second image to represent the final stop time of the video content that was previously played by the second device.

17. The method of claim 16, further comprising:
displaying a first device icon to represent the first device in association with the first image; and
displaying a second device icon to represent the second device in association with the second image.

18. The method of claim 17, further comprising:
receiving an input to select the second device icon; and
playing the video content starting from the final stop time.

19. The method of claim 16, further comprising:
displaying a content sharing icon that is configured to receive input instructions to authorize the second device to play the video content.

20. The method of claim 16, further comprising:
displaying a play icon that is configured to receive input instructions for the second device to play the video content starting from the current playing time.
